(19) United States
(12) Patent Application Publication
(10) Pub. No.: US 2026/0274192 A1
(43) Pub. Date: Sep. 17, 2026

(54) AIR BAG DEVICE

(71) Applicant: HYUNDAI MOBIS CO., LTD., Seoul (KR)

(72) Inventor: Sang Won HWANGBO, Yongin-si (KR)

(73) Assignee: HYUNDAI MOBIS CO., LTD., Seoul (KR)

(21) Appl. No.: 19/348,913

(22) Filed: Oct. 3, 2025

(30) Foreign Application Priority Data
Mar. 12, 2025 (KR) 10-2025-0032251

(51) Int. Cl. B60R 21/233; B60R 21/2338; B60R 21/00

(52) U.S. Cl. CPC B60R 21/233; B60R 21/2338; B60R 2021/0048; B60R 2021/23386

(57) ABSTRACT

An air bag device includes an airbag cushion to be deployed in a shape covering a side and a front of an occupant, and a front tether connected to the airbag cushion and passing over an upper shoulder area of the occupant between the airbag cushion and a seat back, and to be deployed by being filled with gas at an interior thereof.

### CROSS REFERENCE TO THE RELATED APPLICATION

This application claims priority from Korean Patent Application No. 10-2025-0032251 filed on Mar. 12, 2025 in the Korean Intellectual Property Office, the disclosure of which is incorporated herein by reference in its entirety.

### BACKGROUND

### Field

The present disclosure relates to an air bag device that prevents injury risk that may occur when a tether deployed between an omnidirectional airbag and a seat comes into contact with body parts of an occupant.

### Description of the Related Art

In the case of an omnidirectional airbag that is deployed in a shape covering both the side and front of an occupant, a front chamber is connected to a side chamber to form an airbag cushion.

The airbag cushion is folded on the left and right sides of the seat, and when a vehicle collision occurs, the airbag cushion is deployed toward the front of the occupant, thereby surrounding the side and front of the occupant to protect the occupant.

However, if the side chamber and the front chamber rotate outward and spread excessively during the deployment process of the airbag cushion, a space is created in front of the occupant, making it difficult to safely restrain the occupant.

Accordingly, by connecting a tether between the side chamber and/or the front chamber and the seat, the tether restricts the front chamber from rotating outward to regulate the deployment shape of the airbag cushion.

However, in the case of a tether connected between the upper portion of the seat back and the airbag cushion, during the process of the tether being deployed together with the airbag cushion, the tether may cause friction against the neck area of the occupant, and there is a concern that this may cause injuries such as lacerations and puncture wounds to the occupant's neck.

Therefore, there is a need for an air bag device that prevents injury risk that may occur when a tether deployed between an omnidirectional airbag and a seat comes into contact with body parts of an occupant.

The above matters disclosed in this section are merely for enhancement of understanding of the general background of the disclosure and should not be taken as an acknowledgement or any form of suggestion that the matters form the related art already known to a person skilled in the art.

### SUMMARY

Therefore, the present disclosure has been made in view of the above problems, and it is an object of the present disclosure to provide an air bag device that prevents injury risk that may occur when a tether deployed between an omnidirectional airbag and a seat comes into contact with body parts of an occupant.

Objects are not limited to the above-mentioned technical objects, and other technical objects not mentioned will be clearly understood by those skilled in the art to which the present disclosure belongs from the description below.

The above and other objects can be accomplished by the provision of an air bag device according to the present disclosure. The air bag device comprises an airbag cushion configured to be deployed in a shape covering a side and a front of an occupant, and a front tether connected to the airbag cushion and passing over an upper shoulder area of the occupant between the airbag cushion and a seat back, and configured to be deployed by being filled with gas at an interior thereof.

The front tether and the airbag cushion may be configured to share the gas.

The airbag cushion may comprise a side chamber configured to be deployed in a shape covering the side of the occupant, and a front chamber configured to be deployed in a shape covering the front of the occupant, and the front tether may be connected to the front chamber and configured to share gas filled at the interior thereof.

Gas at an interior of the front chamber may be filled at the interior of the front tether.

A connection portion of the front chamber and the front tether may be integrally formed in a shape in which the connection portion is in communication, and may share gas filled at the interior thereof.

Flow holes may be respectively disposed at connection portions of the side chamber and the front chamber, and the flow holes of the side chamber and the front chamber may be connected in a state in which the flow holes are aligned, and interiors of the side chamber and the front chamber may be in communication through the flow holes.

A plurality of the flow holes may be disposed along a vertical length direction of the connection portions of the side chamber and the front chamber.

A side tether may be connected to the airbag cushion at a position passing over the upper shoulder area of the occupant between the connection portions of the side chamber and the front chamber and the seat back.

The front tether may extend from the seat back toward the airbag cushion.

The front tether may be configured such that gas is filled at an interference region on one side toward a neck area of the occupant, and gas is not filled at a non-interference region on another side.

An assembly hole may be disposed at an end of the front tether and may be connected to the seat back, and the front tether may be configured such that gas is not filled at a portion of the front tether at which the assembly hole is disposed.

According to the present disclosure, the front tether is deployed in a form that is inflated by being filled with gas at the interior thereof. Accordingly, due to the volume of the inflated front tether, an outer surface of the front tether toward the neck area of the occupant is formed in a curved shape. Therefore, even if the front tether comes into contact with the neck area of the occupant, the curved outer surface of the front tether makes contact, thereby having an effect of preventing injury risk such as lacerations and puncture wounds of the occupant due to the front tether.

Effects obtainable from the present disclosure are not limited to the above-mentioned effects, and other effects not mentioned will be clearly understood by those skilled in the art to which the present disclosure belongs from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an air bag device according to an embodiment of the present disclosure in an operated state;

FIG. 2 shows the airbag cushion according to the present disclosure in a deployed form;

FIG. 3 shows a cross-section taken along line A-A in FIG. 2;

FIG. 4 shows the side chamber and the front chamber according to the present disclosure in a separated state; and

FIG. 5 shows the side chamber and the front chamber of FIG. 4 in a state where flow holes are aligned.

### DETAILED DESCRIPTION

Hereinafter, embodiments of the present disclosure will be described in detail with reference to the accompanying drawings, and the same or similar elements are designated by the same reference numerals regardless of the numerals in the drawings, and redundant description thereof will be omitted.

In describing the embodiments disclosed in this specification, when it is determined that a detailed description of related known technologies may obscure the gist of the embodiments disclosed in this specification, the detailed description will be omitted. In addition, the accompanying drawings are only for easy understanding of the embodiments disclosed in this specification, and the technical ideas disclosed in this specification are not limited by the accompanying drawings, and should be understood to include all changes, equivalents, and substitutes included in the spirit and technical scope of the present disclosure. The following disclosure is not intended to limit the present disclosure to the described form or specific field, and it is considered that various alternative aspects and modifications of the present disclosure are possible, whether explicitly described or implied in this specification. Those skilled in the art to which the present disclosure belongs will recognize that the form and details of the content of the present disclosure may be changed.

The content of the present disclosure is described with reference to specific aspects. However, as understood by those skilled in the art to which the present disclosure belongs, various aspects disclosed in this specification may be modified or otherwise implemented in various other ways without departing from the spirit and scope of the content of the present disclosure. Therefore, the following description should be considered as illustrative, and is for the purpose of teaching those skilled in the art to which the present disclosure belongs how to make and use various embodiments. It will be understood that the forms of disclosure shown and described in this specification will be taken as representative embodiments. Equivalent elements, or materials, processes or steps may be substituted for those representatively illustrated and described in the present disclosure. Expressions such as "including", "comprising", "incorporating", "consisting of", "have", "is", etc. used in describing the present disclosure should be interpreted in a non-exclusive manner, that is, to allow items, components or elements not explicitly described to also be displayed. In addition, references to the singular should be interpreted to include those related to the plural.

In addition, various embodiments disclosed in this specification should be accepted in an illustrative and explanatory sense, and should not be interpreted as limiting the content of the present disclosure. All references to joining (for example, attached, affixed, coupled, connected, etc.) are used only to help understand the present disclosure, and do not limit the position, direction or use of the configuration or the methods disclosed in this specification. Therefore, where joining references exist, they should be interpreted broadly. Moreover, in these joining references, it is not determined that two or more elements are directly connected to each other. Additionally, all numerical terms, for example, "first", "second", "third", "primary", "secondary", "main" or any other general terms or numerical terms, should only be taken as identifiers to assist in understanding various components, forms, changes or modifications of the present disclosure, and do not mean limitations to any component, form, change or modification or their order or preference. That is, these expressions may be used to describe various components, but the components are not limited by the expressions. The expressions are used only for the purpose of distinguishing one component from another component.

The suffixes "module" and "unit" for components used in the following description are given or used in combination only in consideration of the ease of writing the specification, and do not have meanings or roles that are distinct from each other.

When a component is referred to as being "connected" or "connected" to another component, it should be understood that it may be directly connected or connected to the other component, but other components may exist in between. On the other hand, when a component is referred to as being "directly connected" or "directly connected" to another component, it should be understood that no other components exist in between.

In addition, the unit or control unit included in the name is only a term widely used in naming controllers that control specific functions of vehicles, and does not mean a generic function unit.

A controller may include a communication device that communicates with other controllers or sensors for control of the function in charge, a memory that stores an operating system, logic commands, input and output information, etc., and one or more processors that perform judgment, calculation, decision, etc. necessary for controlling the function in charge.

Any number of components or various components of any of the configurations described in this specification may be included within the disclosure described in this specification. The components may include any combination of the features described in this specification and may be arranged in any of the various configurations described in this specification. Concepts regarding the structure and arrangement of the components of the present disclosure as well as their use and operation may be applied to the specific embodiments discussed in this specification as well as any number of embodiments of any combination. Embodiments including those having various features of various arrangements are described below with reference to the drawings.

Hereinafter, various embodiments disclosed in this specification will be described in detail with reference to the accompanying drawings, and the same or similar components are given the same reference numbers regardless of the drawing symbols, and redundant descriptions thereof will be omitted.

The air bag device according to the present disclosure comprises an airbag cushion 10 configured to be deployed in a shape covering a side and a front of an occupant, and a front tether 110 connected at a position passing over an upper shoulder area of the occupant between the airbag cushion 10 and a seat back 20, and configured to be deployed by being filled with gas at an interior thereof.

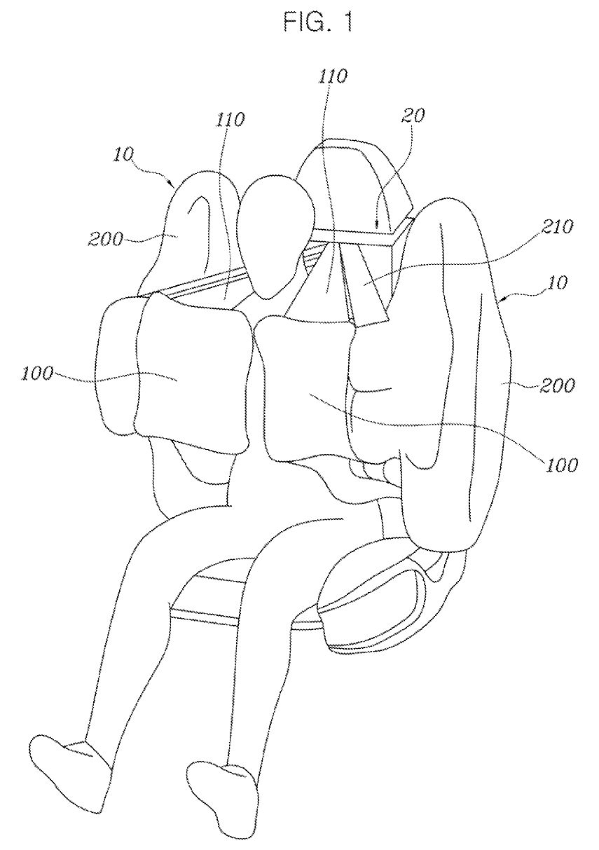

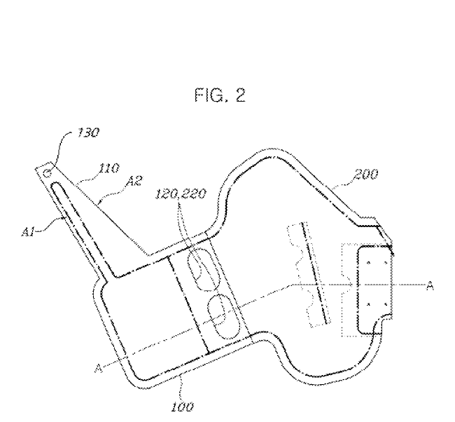

Referring to FIGS. 1 and 2, the airbag cushion 10 comprises a side chamber 200 configured to be deployed in a shape covering the side of the seat, and a front chamber 100 configured to be deployed in a shape covering the front of the seat.

The side chamber 200 is deployed toward the front from the left and right sides of the seat back 20, respectively, and is deployed to extend long in the vertical length direction.

The side chamber 200 is deployed into the space between vehicle structures such as doors and center consoles and the occupant to protect major body parts on the side of the occupant, including the head, shoulder, chest, abdomen, and pelvis.

The front chamber 100 is connected to the front ends of the left and right side chambers 200, respectively, and is deployed in a shape that bends toward the front of the occupant.

The front chamber 100 is deployed to protect the area from the shoulder to the abdomen of the occupant.

That is, the side chambers 200 and the front chambers 100 are deployed from the left and right sides of the seat in a shape that entirely surrounds both sides of the occupant and the front of the occupant.

Accordingly, by directly restraining the occupant for various positions of seats and occupant postures, it is possible to respond to various collision modes to safely protect the occupant, and it is possible to replace not only airbags in other parts but also seat belts, thereby greatly improving marketability.

The front tether 110 may be connected between an upper portion of the airbag cushion 10 and an upper portion of the seat back 20.

The front tether 110 has a front end connected to an upper portion of the front chamber 100, and a rear end connected to an upper portion of the seat back 20.

For example, the front tether 110 may be connected from the upper portion of the front chamber 100, passing over the shoulder of the occupant, to a seat back frame (not shown) embedded in the upper portion of the seat back 20.

At this time, since the airbag cushion 10 of the present disclosure is deployed from both sides of the seat, the front tether 110 connected to the upper left of the seat back 20 is connected to the upper portion of the right front chamber 100, and the front tether 110 connected to the upper right of the seat back 20 is connected to the upper portion of the left front chamber 100, so that the left and right front tethers 110 cross around the neck area of the occupant, thereby strengthening the restraint force of the airbag cushion 10.

However, due to this, the front tether 110 may come into contact with the neck area of the occupant during the deployment process of the airbag cushion 10.

Accordingly, the front tether 110 of the present disclosure is deployed in a form that is inflated by being filled with gas at the interior thereof. Accordingly, due to the volume of the inflated front tether 110, an outer surface of the front tether 110 toward the neck area of the occupant is formed in a curved shape.

Therefore, even if the front tether 110 comes into contact with the neck area of the occupant, the curved outer surface of the front tether 110 makes contact, thereby preventing injury risk such as lacerations and puncture wounds of the occupant due to the front tether 110.

Meanwhile, in the present disclosure, the gas at the interior of the front tether 110 is configured to share gas at an interior of the airbag cushion 10.

That is, an inflator (not shown) is a device that operates explosively according to a collision signal of the vehicle to generate gas, and when the airbag operates, the airbag cushion 10 is inflated and deployed by gas generated from the inflator, and the gas that inflates the airbag cushion 10 is also supplied to the interior of the front tether 110 so that the front tether 110 can be inflated and deployed together with the airbag cushion 10.

More specifically, the airbag cushion 10 comprises a side chamber 200 configured to be deployed in a shape covering the side of the occupant, and a front chamber 100 configured to be deployed in a shape covering the front of the occupant, and the front tether 110 is connected to the front chamber 100 and is configured to share gas filled at the interior thereof.

Preferably, gas at an interior of the front chamber 100 may be filled at an interior of the front tether 110.

That is, a front end of the front tether 110 may be connected to an upper portion of the front chamber 100 so as to be in communication.

Accordingly, the side chamber 200 and the front chamber 100 are inflated by gas generated from the inflator, and the gas filled in the front chamber 100 flows to the interior of the front tether 110 so that the front tether 110 can be inflated and deployed.

In addition, the present disclosure is configured such that a connection portion of the front chamber 100 and the front tether 110 is integrally formed in a shape in which the connection portion is in communication, and shares gas filled at the interior thereof.

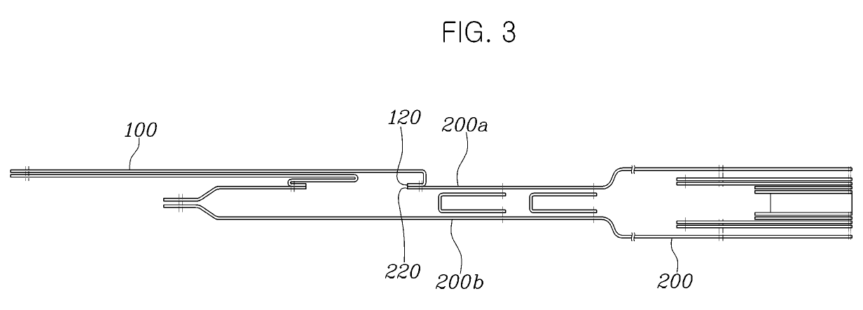

Referring to FIGS. 2 to 4, the front chamber 100 is provided with a rectangular panel 100a that forms the front chamber 100, and horn-shaped panels 100b that form the front tether 110 are integrally formed on both upper sides of the panel 100a of the front chamber 100, and the panel 100a of the front chamber 100 and the panels 100b of the front tether 110 are formed symmetrically.

Accordingly, after folding in half around the center of the panel 100a of the front chamber 100, the front chamber 100 and the front tether 110 are integrally formed by stitching along the outer edges of the folded panels 100a and 100b.

In particular, since the interior of the front chamber 100 and the interior of the front tether 110 are in communication, gas filled in the interior of the front chamber 100 can be supplied to the interior of the front tether 110 to inflate the front tether 110 when the airbag cushion 10 is deployed.

In addition, in the present disclosure, flow holes are respectively formed at connection portions of the side chamber 200 and the front chamber 100, and the flow holes of the side chamber 200 and the front chamber 100 are connected in a state in which the flow holes are aligned, and interiors of the side chamber 200 and the front chamber 100 can be in communication through the flow holes.

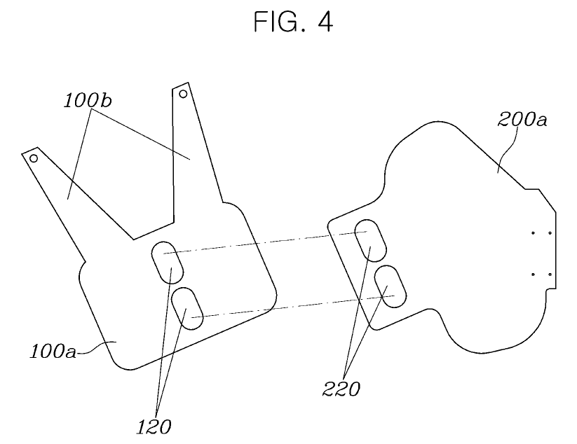

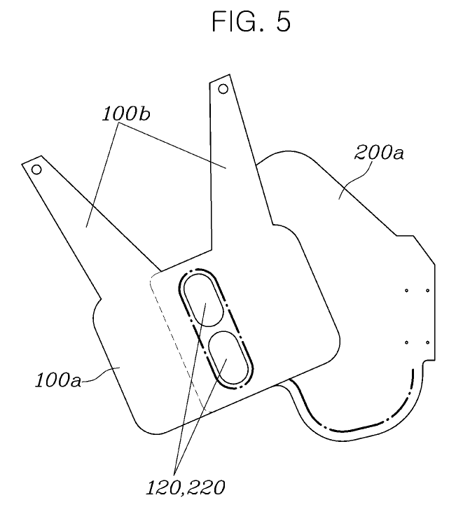

Referring to FIGS. 4 and 5, the side chamber 200 is configured by stitching outer edges of an inner inboard panel 200a and an outer outboard panel 200b, and an inflator is inserted into a rear end of the side chamber 200 to provide gas from the inflator to the interior of the side chamber 200.

A first flow hole 120 is formed at a front end of the inboard panel 200a, and a second flow hole 220 corresponding to the first flow hole 120 is formed in the center of the panel 100a of the front chamber 100.

Accordingly, by aligning the first flow hole 120 and the second flow hole 220 and stitching along the outer edges of the first flow hole 120 and the second flow hole 220, the interior of the side chamber 200 and the interior of the front chamber 100 are in communication through the first flow hole 120 and the second flow hole 220.

Therefore, gas from the inflator provided in the side chamber 200 can flow to the interior of the front chamber 100 through the first flow hole 120 and the second flow hole 220.

In addition, a plurality of the flow holes may be formed along a vertical length direction of the connection portions of the side chamber 200 and the front chamber 100.

For example, a front end of the side chamber 200 and one end of the front chamber 100 respectively become connection portions.

Accordingly, two first flow holes 120 are respectively formed at upper and lower portions of the front end, which is the connection portion of the side chamber 200, and two second flow holes 220 are respectively formed at upper and lower portions of one end, which is the connection portion of the front chamber 100.

Therefore, since a plurality of flow holes are formed along the vertical length direction at the connection portions of the side chamber 200 and the front chamber 100, gas in the side chamber 200 can stably flow to the interior of the front chamber 100.

Meanwhile, in the present disclosure, a side tether 210 may be connected at a position passing over the upper shoulder area of the occupant between the connection portions of the side chamber 200 and the front chamber 100 and the seat back 20.

Preferably, a front end of the side tether 210 may be connected to an interior of the inboard panel 200a of the side chamber 200 or the panel 100a of the front chamber 100, and a rear end of the side tether 210 may be connected to an upper portion of the seat back 20.

That is, separately from the front tether 110, a side tether 210 made of fabric may be further connected between a rear end of the seat back 20 and the side chamber 200, and the side tether 210 can prevent the side tether 210 from spreading excessively outward.

For reference, the front tether 110 and the side tether 210 may also be connected between a lower portion of the airbag cushion 10 and a lower portion of the seat back 20.

That is, a lower front tether 110 may have a front end connected to a lower portion of the front chamber 100, and a rear end connected to a seat back frame embedded in a lower portion of the seat back 20, passing over the thigh of the occupant.

In addition, a lower side tether 210 may have a front end connected to a lower connection portion of the front chamber 100 and the side chamber 200, and a rear end connected to a seat back frame embedded in a lower portion of the seat back 20.

Meanwhile, in the present disclosure, the front tether 110 may be formed in a shape extending from the seat back 20 toward the airbag cushion 10.

As shown in FIGS. 1 and 2, the front tether 110 is formed in a right triangular shape, wherein a width direction width of a rear end of the front tether 110 connected to the seat back 20 is formed to be relatively narrow, and the width direction width is formed to gradually widen toward a front end of the front tether 110 connected to the airbag cushion 10. Accordingly, since a left-right width direction length where the front chamber 100 and the front tether 110 are connected becomes longer, the deployment shape of the front chamber 100 can be more stably regulated by the front tether 110.

In addition, the front tether 110 may be formed such that gas is filled at an interference region A1 on one side toward a neck area of the occupant, and gas is not filled at a non-interference region A2 on another side.

Referring to FIG. 2, based on a front-rear length direction of the front tether 110, one side toward the neck area of the occupant becomes an interference region A1, and another side toward the side chamber 200 can be divided into a non-interference region A2.

Accordingly, when stitching the front chamber 100, the front tether 110 is stitched so that gas is filled only in the interference region A1 formed along one side of the front tether 110.

The reason is that if the front tether 110 is stitched entirely along the outer edge of the front tether 110, including the non-interference region A2 of the front tether 110, gas filled in the airbag cushion 10 may be used due to an unnecessary increase in volume, leading to a problem where the volume of the airbag cushion 10 is relatively reduced. Therefore, the volume of the front tether 110 can be optimized by filling gas only in the interference region A1.

In addition, an assembly hole 130 may be formed at an end of the front tether 110 and may be connected to the seat back 20, and the front tether 110 may be formed such that gas is not filled at a portion of the front tether 110 at which the assembly hole 130 is formed.

That is, an assembly hole 130 is formed at a rear end portion of the front tether 110, and the assembly hole 130 is connected to a seat back frame.

As such, since the assembly hole 130 portion is a portion that is assembled with the seat back 20 and gas should not enter, the rear end portion of the front tether 110 where the assembly hole 130 is formed is set so that gas does not enter through stitching.

As such, the present disclosure has the front tether 110 deployed in a form that is inflated by being filled with gas at the interior thereof. Accordingly, due to the volume of the inflated front tether 110, an outer surface of the front tether 110 toward the neck area of the occupant is formed in a curved shape.

Therefore, even if the front tether 110 comes into contact with the neck area of the occupant, the curved outer surface of the front tether 110 makes contact, thereby preventing injury risk such as lacerations and puncture wounds of the occupant due to the front tether 110.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

### REFERENCE NUMERALS

10: Airbag cushion 20: Seat back 100: Front chamber 110: Front tether 120: First flow hole 130: Assembly hole 200: Side chamber 210: Side tether 220: Second flow hole A1: Interference region A2: Non-interference region

What is claimed is:

1. An air bag device comprising:
an airbag cushion configured to be deployed in a shape covering a side and a front of an occupant; and
a front tether connected to the airbag cushion and passing over an upper shoulder area of the occupant between the airbag cushion and a seat back, and configured to be deployed by being filled with gas at an interior thereof.

2. The air bag device according to claim 1, wherein the front tether and the airbag cushion are configured to share the gas.

3. The air bag device according to claim 1, wherein the airbag cushion comprises:
a side chamber configured to be deployed in a shape covering the side of the occupant; and
a front chamber configured to be deployed in a shape covering the front of the occupant,
wherein the front tether is connected to the front chamber and configured to share the gas filled at the interior thereof.

4. The air bag device according to claim 3, wherein gas at an interior of the front chamber is filled at the interior of the front tether.

5. The air bag device according to claim 3, wherein a connection portion of the front chamber and the front tether is integrally formed in a shape in which the connection portion is in communication, and shares gas filled at the interior thereof.

6. The air bag device according to claim 3, wherein flow holes are respectively disposed at connection portions of the side chamber and the front chamber, and
wherein the flow holes of the side chamber and the front chamber are connected in a state in which the flow holes are aligned, and interiors of the side chamber and the front chamber are in communication through the flow holes.

7. The air bag device according to claim 6, wherein a plurality of the flow holes are disposed along a vertical length direction of the connection portions of the side chamber and the front chamber.

8. The air bag device according to claim 3, further comprising a side tether connected to the airbag cushion at a position passing over the upper shoulder area of the occupant between the connection portions of the side chamber and the front chamber and the seat back.

9. The air bag device according to claim 1, wherein the front tether extends from the seat back toward the airbag cushion.

10. The air bag device according to claim 1, wherein the front tether is configured such that gas is filled at an interference region on one side toward a neck area of the occupant, and gas is not filled at a non-interference region on another side.

11. The air bag device according to claim 1, wherein an assembly hole is disposed at an end of the front tether and is connected to the seat back, and
wherein the front tether is configured such that gas is not filled at a portion of the front tether at which the assembly hole is disposed.
